(19) United States
(12) Patent Application Publication
(10) Pub. No.: US 2017/0339680 A1
(43) Pub. Date: Nov. 23, 2017

(54) TX SCHEDULING USING HYBRID SIGNALING TECHNIQUES

(71) Applicant: QUALCOMM Incorporated, San Diego, CA (US)

(72) Inventors: Zhanfeng Jia, Belmont, CA (US); Alireza Raissinia, Monte Sereno, CA (US); James Cho, Mountain View, CA (US); Sandip Homchaudhuri, San Jose, CA (US); Senthil Subramanian, San Jose, CA (US); Alfred Asterjadhi, San Diego, CA (US); Naveen Kumar Kakani, Coppell, TX (US)

(21) Appl. No.: 15/595,161

(22) Filed: May 15, 2017

Related U.S. Application Data
(60) Provisional application No. 62/339,674, filed on May 20, 2016.

(51) Int. Cl. H04W 72/04; H04W 28/02; H04W 28/16; H04W 28/18

(52) U.S. Cl. CPC H04W 72/042; H04W 28/18; H04W 28/02; H04W 28/16

(57) ABSTRACT

A system and method for managing communications between an access point (AP) and a plurality of wireless stations (STAs) over a wireless medium. The AP schedules each of the plurality of STAs to access the wireless medium during a target wake time (TWT) service period. During a first portion of the TWT service period, the AP communicates with a first subset of the plurality of STAs using a first signaling technique. During a second portion of the TWT service period, the AP communicates with a second subset of the plurality of STAs using a second signaling technique. The second subset of the plurality of STAs does not include any STAs from the first subset.

### CROSS-REFERENCE TO RELATED APPLICATIONS

This application claims priority under 35 USC 119(e) to co-pending and commonly owned U.S. Provisional Patent Application No. 62/339,674 entitled “TX SCHEDULING USING HYBRID SIGNALING TECHNIQUES,” filed on May 20, 2016, the entirety of which is incorporated by reference herein.

### TECHNICAL FIELD

The present embodiments relate generally to wireless communications systems, and specifically to methods of scheduling communications over a wireless medium using hybrid signaling techniques.

### BACKGROUND OF RELATED ART

A wireless local area network (WLAN) may be formed by one or more access points (APs) that provide a shared wireless medium for use by a number of client devices or stations (STAs). Each AP, which may correspond to a Basic Service Set (BSS), periodically broadcasts beacon frames to enable any STAs within wireless range of the AP to establish and/or maintain a communication link with the WLAN. In a typical WLAN, only one STA may use the wireless medium at any given time, and each STA may be associated with only one AP at a time. WLANs that operate in accordance with the IEEE 802.11 family of standards are commonly referred to as Wi-Fi networks.

In a Wi-Fi network, wireless devices (such as APs and STAs) typically compete for access to the wireless communication medium. For example, the devices may use carrier sense multiple access collision avoidance (CSMA/CA) techniques to “listen” to the wireless medium to determine when the wireless medium is idle. When the wireless medium has been idle for a given duration, the devices may “contend” for medium access (such as by waiting a random “back-off” period before attempting to transmit on the wireless medium). The winning device may be granted exclusive access to the shared wireless medium for a period of time commonly referred to as a transmit opportunity (TXOP), during which only the winning device may transmit (and/or receive) data over the shared wireless medium.

Because CSMA requires all wireless devices to regularly contend for access to the wireless medium, and because only one wireless device may communicate over the wireless medium at any given time, individual devices (and the wireless medium) may experience significant lulls in communication. Thus, conventional wireless communication techniques may be inefficient and/or may underutilize the available bandwidth in a Wi-Fi network.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A system and method for managing communications between an access point (AP) and a plurality of wireless stations (STAs) is disclosed. The AP schedules each of the plurality of STAs to access a wireless medium during a first target wake time (TWT) service period. During a first portion of the first TWT service period, the AP communicates with a first subset of the plurality of STAs using a first signaling technique. During a second portion of the TWT service period, the AP communicates with a second subset of the plurality of STAs using a second signaling technique. In example implementations, the second subset of the plurality of STAs does not include any STAs from the first subset.

The first signaling technique may be configured to provide concurrent communications with a greater number of STAs than the second signaling technique. For example, the first signaling technique may be an orthogonal frequency division multiple access (OFDMA) signaling technique. The second signaling technique may be configured to provide greater overall throughput than the first signaling technique. For example, the second signaling technique may be a multi-user multiple-input multiple-output (MU-MIMO) signaling technique.

In some examples, the AP may determine an amount of buffered data associated with each of the plurality of STAs. The AP may further configure respective durations of the first and second portions of the first TWT service period based at least in part on the amount of buffered data. In some aspects, the durations of the first and second portions of the first TWT service period may be further based at least in part on priorities associated with the buffered.

The AP may further communicate with a third subset of the plurality of STAs, during a third portion of the first TWT service period, using a signaling technique that is different than each of the first and second signaling techniques. In some aspects, the AP may release control of the wireless medium during the third portion of the first TWT service period to allow the third subset of the plurality of STAs to contend for access to the wireless medium. This may allow legacy devices to access the wireless medium for a given duration of the TWT service period. In some examples, the AP may schedule the third portion of the first TWT service period to occur between the first and second portions of the first TWT service period.

Still further, the AP may schedule each of the plurality of STAs to access the wireless medium during a second TWT service period. During a first portion of the second TWT service period, the AP may communicate with a third subset of the plurality of STAs using the first signaling technique. During a second portion of the second TWT service period, the AP may communicate with a fourth subset of the plurality of STAs using the second signaling technique. In example implementations, the fourth subset of the plurality of STAs does not include STAs from any of the second or third subsets.

By enabling each of the plurality of STAs to access the wireless medium for at least a minimum (or threshold) duration during each TWT service period, the methods of operation disclosed herein may reduce communications latency for each of the STAs associated with the AP. Moreover, by assigning a “primary” subset of STAs for each TWT service period, the AP may ensure that at least some of the STAs receive relatively high throughput communications (such as by using MU-MIMO signaling techniques) during a given TWT service period and that a different subset of STAs receives such high throughput communications during a different (or subsequent) TWT service period.

### BRIEF DESCRIPTION OF THE DRAWINGS

The embodiments herein are illustrated by way of example and are not intended to be limited by the figures of the accompanying drawings.

FIG. 1 shows an example wireless system within which the example embodiments may be implemented.

FIG. 2 is a timing diagram depicting an example scheduling of access point (AP)-initiated access to a wireless medium.

FIG. 3 shows a block diagram of an access point (AP) in accordance with example embodiments.

FIG. 4 is a timing diagram depicting an example scheduling of access to a wireless medium using hybrid signaling techniques.

FIGS. 5A-5B are timing diagrams depicting example allocations of transmit opportunities (TXOPs) based on different signaling techniques within a given service period.

FIG. 6 is an illustrative flowchart depicting an operation for scheduling access to a wireless medium, in accordance with example embodiments.

FIG. 7 is an illustrative flowchart depicting an example operation for scheduling access to a wireless medium using hybrid signaling techniques.

FIG. 8 is an illustrative flowchart depicting a more detailed operation for scheduling access to a wireless medium using hybrid signaling techniques.

### DETAILED DESCRIPTION

The example embodiments are described below in the context of WLAN systems for simplicity only. It is to be understood that the example embodiments are equally applicable to other wireless networks (such as cellular networks, pico networks, femto networks, satellite networks), as well as for systems using signals of one or more wired standards or protocols (such as Ethernet and/or HomePlug/PLC standards). As used herein, the terms “WLAN” and “Wi-Fi®” may include communications governed by the IEEE 802.11 family of standards, BLUETOOTH® (Bluetooth), HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein.

In addition, although described below in terms of an infrastructure WLAN system including one or more APs and a number of STAs, the example embodiments are equally applicable to other WLAN systems including, for example, multiple WLANs, peer-to-peer systems (operating according to Wi-Fi Direct protocols), Independent Basic Service Set (IBSS) systems, Wi-Fi Direct systems, and/or Hotspots. Further, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. The term “resource unit” or “RU” refers to a grouping of tones or subcarriers in a wireless channel. More specifically, the bandwidth of a wireless network may be subdivided into multiple resource units. Each resource unit may include a finite (or predetermined) number of tones, depending on implementation. The term “downlink” or “DL” refers to communications from an AP to one or more STAs, whereas the term “uplink” or “UL” refers to communications from one or more STAs to an AP. The term “hybrid signaling” refers to an AP using multiple signaling techniques (such as OFDMA and MU-MIMO) to communicate with one or more STAs during a given service period.

Further, as used herein, the term “HE” may refer to a high efficiency frame format or protocol defined, for example, by the IEEE 802.11ax standards; and the term “non-HT” may refer to a legacy frame format or protocol defined, for example, by the IEEE 802.11a/g standards. Thus, the terms “legacy” and “non-HT” may be used interchangeably herein. In addition, the terms “legacy device” or “legacy STA” as used herein may refer to a device that operates according to the IEEE 802.11a/g standards, and the terms “HE device” or “HE STA” may refer to a device that operates according to the IEE 802.11ax and/or 802.11az standards.

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices such as, for example, a combination of a DSP and a microprocessor, a plurality of microprocessors, one or more microprocessors in conjunction with a DSP core, or any other such configuration.

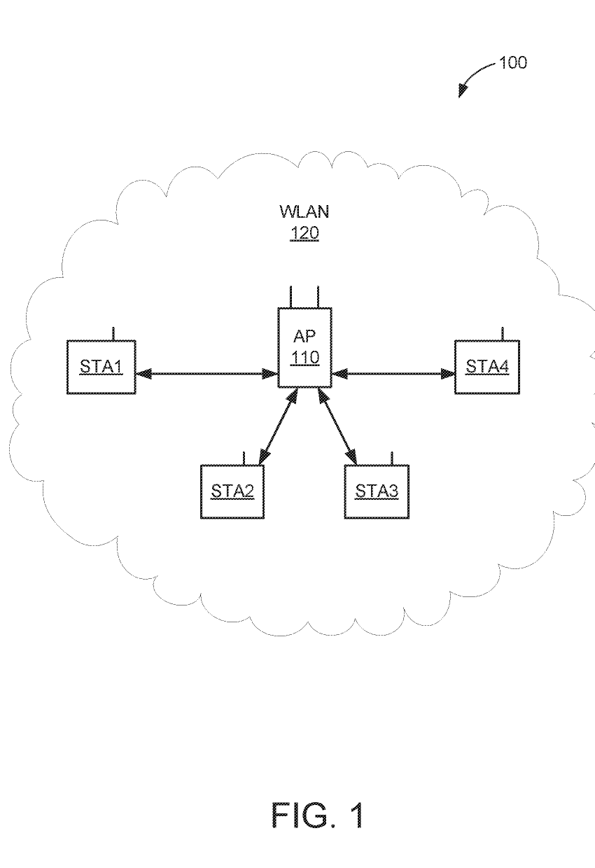

FIG. 1 is a block diagram of a wireless system 100 within which the example embodiments may be implemented. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique media access control (MAC) address that is programmed therein by, for example, the manufacturer of the access point. Similarly, each of stations STA1-STA4 is also assigned a unique MAC address.

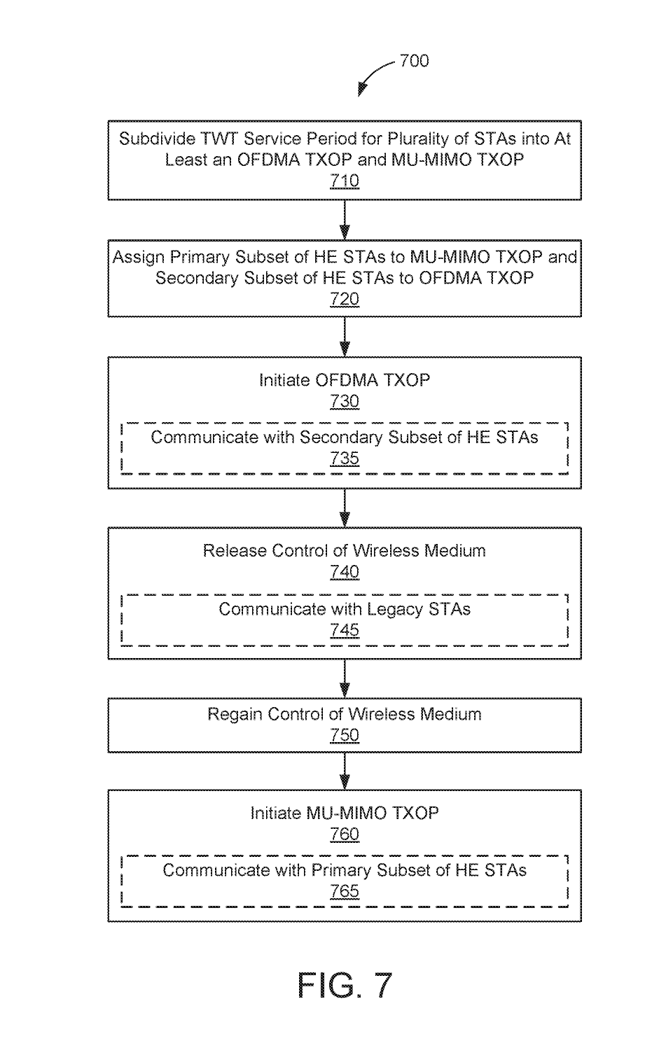

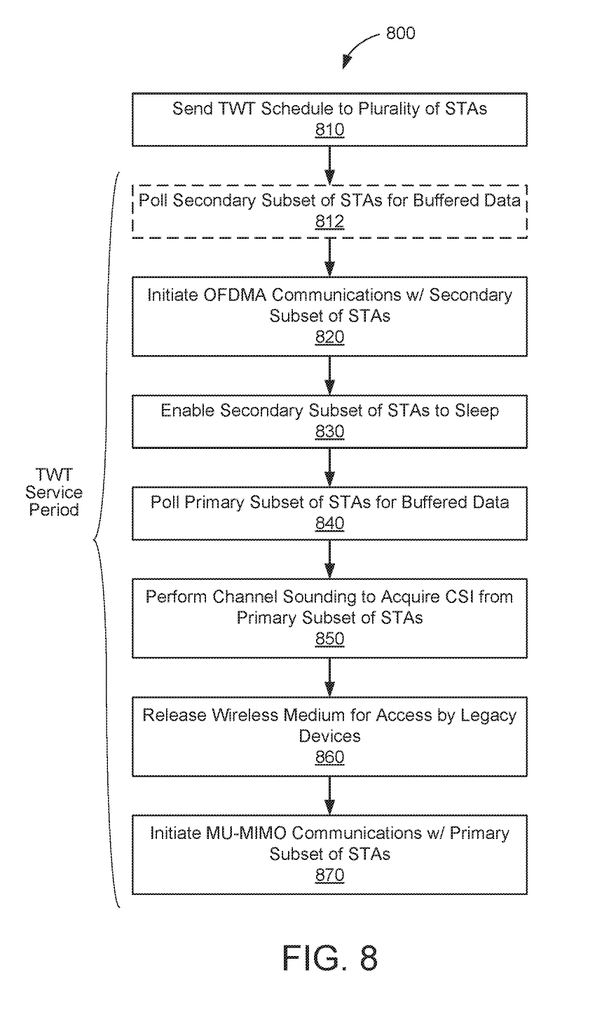

The AP 110 may be any suitable device that allows one or more wireless devices to connect to a network (such as a local area network (LAN), wide area network (WAN), metropolitan area network (MAN), and/or the Internet) via AP 110 using Wi-Fi, Bluetooth, or any other suitable wireless communication standards. The AP 110 may also be any suitable wireless device (such as a wireless station) acting as a software-enabled access point (“SoftAP”). For at least one embodiment, AP 110 may include one or more transceivers, one or more processing resources (processors or ASICs), one or more memory resources, and a power source. The memory resources may include a non-transitory computer-readable medium (such as one or more nonvolatile memory elements, such as EPROM, EEPROM, Flash memory, a hard drive, etc.) that stores instructions for performing operations described below with respect to FIGS. 7-8.

Each of the stations STA1-STA4 may be any suitable Wi-Fi enabled wireless device including, for example, a cell phone, personal digital assistant (PDA), tablet device, laptop computer, or the like. Each station may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station may include one or more transceivers, one or more processing resources (processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that store instructions for communicating with the AP 110 and/or accessing the WLAN 120.

For the AP 110 and/or stations STA1-STA4, the one or more transceivers may include Wi-Fi transceivers, Bluetooth transceivers, NFC transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate with a 2.4 GHz frequency band and/or within a 5 GHz frequency band in accordance with the IEEE 802.11 standards. The cellular transceiver may communicate within various RF frequency bands in accordance with a 4G Long Term Evolution (LTE) protocol described by the 3rd Generation Partnership Project (3GPP) (between approximately 700 MHz and approximately 3.9 GHz) and/or in accordance with other cellular protocols (such as a Global System for Mobile (GSM) communication protocol). In other embodiments, the transceivers may be any technically feasible transceiver such as a ZigBee transceiver described by the ZigBee specification, WiGig transceiver, and/or a HomePlug transceiver described in one or more standards provided by the HomePlug Alliance.

In example embodiments, the AP 110 may schedule and/or manage both downlink (DL) and uplink (UL) communications in the WLAN 120 (referred to hereinafter as “scheduled access”). For example, the IEEE 802.11ax specification defines a “target wake time” (TWT) parameter that may allow the AP 110 to allocate individual timeslots (within a beacon interval) to service a subset of the stations STA1-STA4. During a TWT service period, only the STAs assigned to the particular service period may access the wireless medium (such as to transmit or receive communications via the WLAN 120). In some aspects, the AP 110 may transmit DL data to multiple STAs, concurrently, during the TWT service period (such as by using OFDMA, MU-MIMO, and/or other multi-user signaling techniques). Similarly, the AP 110 may receive UL data from multiple STAs, concurrently, during the TWT service period. Any STAs not assigned to a given TWT service period may be placed in a power saving (or “sleep”) state during that service period.

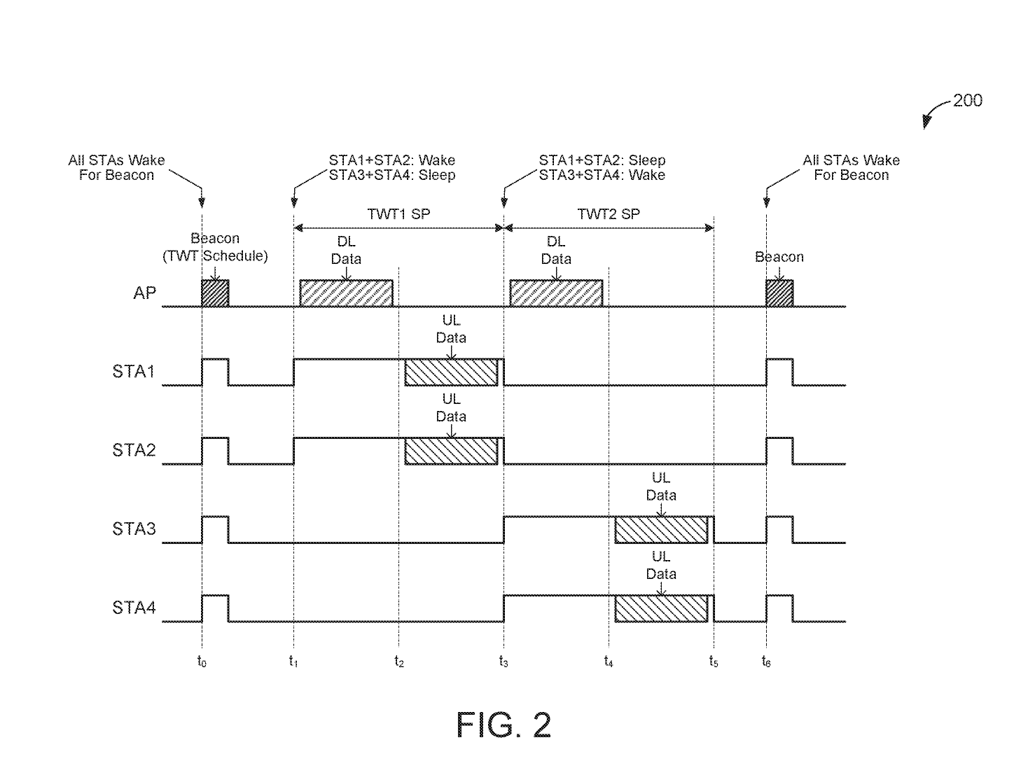

FIG. 2 is a timing diagram 200 depicting an example scheduling of access to a wireless medium. The AP and stations STA1-STA4 may be example embodiments of AP 110 and stations STA1-STA4, respectively, of FIG. 1. For simplicity, only four stations STA1-STA4 are shown in the example of FIG. 2. However, in other embodiments, the AP may schedule access for fewer or more STAs than those depicted in the example of FIG. 2.

The AP broadcasts a beacon frame, at time t₀, to signal the start of a beacon interval (from times t₀ to t₆). At this time, each of the stations STA1-STA4 may wake up from a power saving state (or remain awake, if the STA is not in a power saving state) to receive the beacon frame broadcast from the AP. For example, the AP may broadcast beacon frames at regularly scheduled intervals (such as in accordance with a target beacon transmission time (TBTT)) known to each of the stations STA1-STA4. In example embodiments, the beacon frame may include scheduling information indicating access times for the stations STA1-STA4. In other embodiments, the scheduling information may be provided in unicast frames (such as TWT Setup Action frames) sent by the AP to individual stations STA1-STA4. The scheduling information may include a TWT schedule specifying target wake times for each of the stations STA1-STA4. In the example of FIG. 2, the TWT schedule may indicate a first TWT service period (TWT1 SP) for stations STA1 and STA2, and a second TWT service period (TWT2 SP) for stations STA3 and STA4. To conserve power, after receiving the beacon frame, each of the stations STA1-STA4 may enter a power saving state until their respective TWT service period occurs.

The first TWT service period begins at time t₁. Since stations STA1 and STA2 are scheduled to access the wireless medium (WLAN 120) during the first TWT service period, only STA1 and STA2 may wake up at time t₁. Stations STA3 and STA4 are not scheduled to access the wireless medium during the first TWT service period and may therefore remain in the power saving state. In some aspects, the first TWT service period may be subdivided into a DL transmit opportunity (TXOP) and a UL TXOP. During the DL TXOP, from times t₁ to t₂, the AP may transmit DL data to one or more of the stations STA1 and STA2. In example embodiments, the AP may transmit DL data to the stations STA1 and STA2, concurrently, using well-known MU signaling techniques (such as OFDMA, MU-MIMO, etc.). During the UL TXOP, from times t₂ to t₃, each of the stations STA1 and SAT2 may transmit UL data to the AP. In example embodiments, the stations STA1 and STA2 may transmit the UL data to the AP, concurrently, using well-known MU signaling techniques. Upon completion of the first TWT service period, at time t₃, the stations STA1 and STA2 may return to the power saving state.

The second TWT service period begins at time t₃. Since stations STA3 and STA4 are scheduled to access the wireless medium during the second TWT service period, only STA3 and STA4 may wake up at time t₃. Stations STA1 and STA2 are not scheduled to access the wireless medium during the second TWT service period, and may therefore remain in the power saving state. In some aspects, the second TWT service period may also be subdivided into a DL TXOP and a UL TXOP. During the DL TXOP, from times t₃ to t₄, the AP may transmit DL data to one or more of the stations STA3 and STA4. In example embodiments, the AP may transmit DL data to the stations STA3 and STA4, concurrently, using well-known MU signaling techniques (such as OFDMA, MU-MIMO, etc.). During the UL TXOP, from times t₄ to t₅, each the stations STA3 and STA4 may transmit UL data to the AP. In example embodiments, the stations STA3 and STA4 may transmit the UL data to the AP, concurrently, using well-known MU signaling techniques. Upon completion of the second TWT service period, at time t₅, the stations STA3 and STA4 may return to the power saving state.

In the example of FIG. 2, each of the stations STA1-STA4 wakes up only during its respective TWT service period (other than to receive beacon frames), and remains in the power saving state for the remainder of the beacon interval (between times t₀ and t₆). Although this method of scheduling provides contention-free (and collision-free) access to the wireless medium by each of the stations STA1-STA4, it may not provide the most efficient use of available bandwidth. For example, individual STAs may need to wait long periods to gain (or regain) access to the wireless medium (such as during a scheduled TWT service period), which increases the latency of their communications. As the number of STAs in a WLAN increases, the number of scheduled TWT service periods (within a given beacon interval) may also increase. However, to accommodate the increase in TWT service periods, the duration of each service period (and thus, the amount of time each STA has access to the wireless medium) is typically shortened or reduced.

The example implementations recognize that the communications latency for each of the stations STA1-STA4 may be reduced by enabling most, if not all, of the stations STA1-STA4 to access the wireless medium for at least a short duration during each TWT service period. For example, in some embodiments, the AP may allow stations STA3 and STA4 to transmit and/or receive short bursts of data during a TWT service period scheduled (primarily) for stations STA1 and STA2 (such as the first TWT service period shown in FIG. 2). In this example, stations STA1 and STA2 may correspond to a “primary subset” of STAs for a given TWT service period, and stations STA3 and STA4 may correspond to a “secondary subset” of STAs for the same service period. Similarly, the AP may allow stations STA1 and STA2 to transmit and/or receive short bursts of data during a TWT service period scheduled (primarily) for stations STA3 and STA4 (such as the second TWT service period shown in FIG. 2). In this example, stations STA3 and STA4 may correspond to the primary subset of STAs for a given TWT service period, and stations STA1 and STA2 may correspond to the secondary subset of STAs for the same service period.

In example embodiments, the AP may allocate at least a portion of each TWT service period to communicating with each subset of STAs. Moreover, the AP may use different signaling techniques to communicate with the different subsets of STAs (STA1/STA2 or STA3/STA4) based on their respective “priorities” within a given TWT service period. In some aspects, when communicating with the primary subset of STAs for a given TWT service period, the AP may utilize a multi-user signaling technique (such as MU-MIMO) that is configured to maximize the aggregate throughput of communications for each associated STA. In some other aspects, when communicating with the secondary subset of STAs for a given TWT service period, the AP may utilize a multi-user signaling technique (such as OFDMA) that is configured to maximize the number of STAs with which the AP may concurrently communicate. By using such hybrid signaling techniques, the AP may provide an optimal level of service to the primary subset of STAs for a given TWT service period, while also reducing the latency of communications for the remaining (secondary subset of) STAs.

Multi-user multiple-input multiple-output (MU-MIMO) signaling techniques (such as described in the IEEE 802.11ac specification) leverage antenna diversity to enable a transmitting (TX) device to transmit a plurality of parallel spatial streams to a plurality of receiving (RX) devices at substantially the same time. More specifically, the TX device may use channel sounding techniques to optimize communications with each of the RX devices. For example, channel sounding techniques are typically used for estimating the wireless channel conditions between the TX device and RX devices. However, because MU-MIMO relies on antenna diversity, the TX device may be able to transmit MU-MIMO signals to only a limited number (typically 4-8) of RX devices at the same time.

Orthogonal frequency-division multiple access (OFDMA) signaling techniques (such as described in the IEEE 802.11ax specification) leverage orthogonality principles to enable a TX device to transmit multiple streams of data, in parallel (over orthogonal subcarriers), to multiple RX devices at substantially the same time. More specifically, the IEEE 802.11ax specification defines a “resource unit” (RU) as a logical grouping or collection of subcarriers that may be individually allocated to one or more wireless devices (for concurrent communications). However, because each RU may correspond to a small portion of the total available bandwidth, each RX device may be able to achieve only limited communications throughput depending on the allocation of RUs and/or the number of RX devices in the WLAN.

For at least the reasons above, the example implementations recognize that MU-MIMO signaling techniques may provide a higher aggregate throughput of communications to a limited number of STAs, whereas OFDMA signaling techniques may provide lower latency communications to a greater number of STAs. Thus, for some embodiments, the AP may utilize MU-MIMO signaling techniques when communicating with the primary subset of STAs of a given TWT service period. Further, for some embodiments, the AP may utilize OFDMA signaling techniques when communicating with the secondary subset of STAs of a given service period.

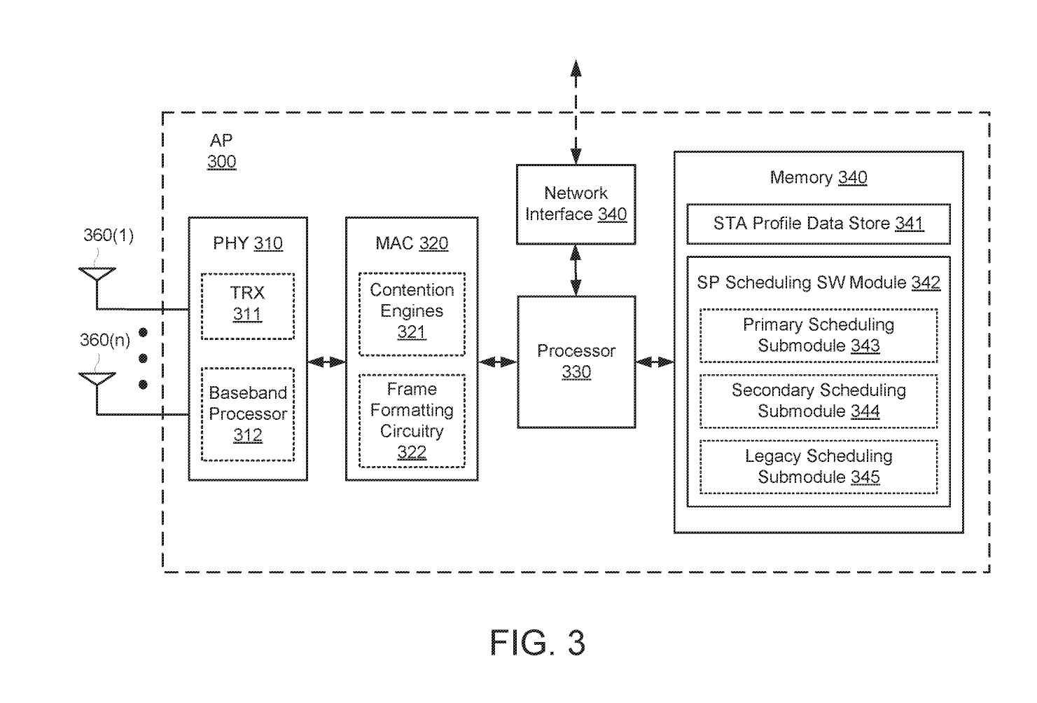

FIG. 3 shows a block diagram of an access point (AP) 300 in accordance with example embodiments. The AP 300 may be one embodiment of AP 110 of FIG. 1. The AP 300 may include at least a PHY device 310, a MAC 320, a processor 330, a memory 340, a network interface 350, and a number of antennas 360(1)-360(n). The network interface 350 may be used to communicate with a WLAN server (not shown for simplicity) either directly or via one or more intervening networks, and to transmit signals.

The PHY device 310 may include at least a number of transceivers 311 and a baseband processor 312. The transceivers 311 may be coupled to antennas 360(1)-360(n), either directly or through an antenna selection circuit (not shown for simplicity). The transceivers 311 may be used to communicate wirelessly with one or more STAs, APs, and/or suitable wireless devices. The baseband processor 312 may be used to process signals received from processor 330 and/or memory 340 and to forward the processed signals to transceivers 311 for transmission via one or more of the antennas 360(1)-360(n). The baseband processor 312 may also be used to process signals received from one or more of the antennas 360(1)-360(n) via transceivers 311 and to forward the processed signals to processor 330 and/or memory 340.

The MAC 320 may include at least a number of contention engines 321 and frame formatting circuitry 322. The contention engines 321 may contend for access to the shared wireless medium, and may also store packets for transmission over the shared wireless medium. For some embodiments, the contention engines 321 may be separate from MAC 320. The frame formatting circuitry 322 may be used to create and/or format frames received from processor 330 and/or memory 340 (such as by adding MAC headers to PDUs provided by processor 330), and may be used to re-format frames received from PHY device 310 (such as by stripping MAC headers from frames received from PHY device 310).

Memory 340 may include a STA profile data store 341 that stores profile information for a plurality of wireless stations. The profile information for a particular STA may include information such as, for example, the STA's MAC address, supported data rates, channel state information (CSI), resource unit allocation, performance metrics (such as link rate, average throughput, etc.), DL buffer size, UL buffer size, and any other suitable information pertaining to or describing the operation of the STA.

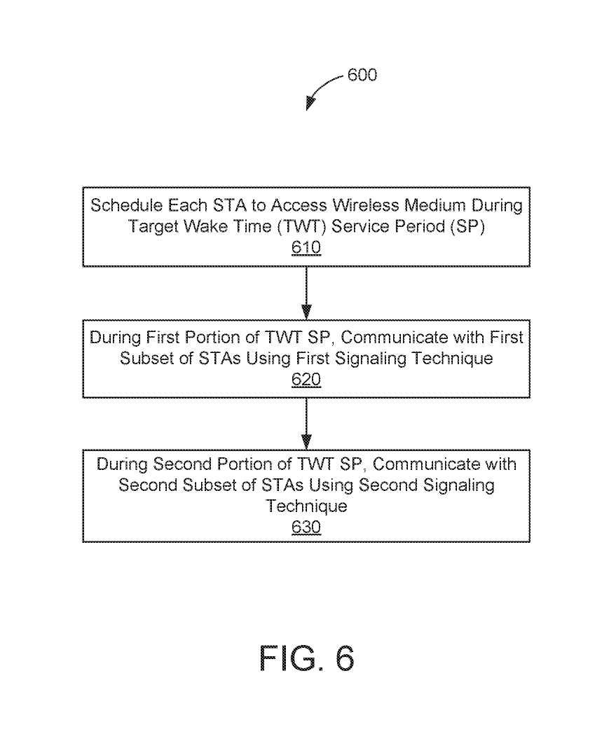

Memory 340 may also include a non-transitory computer-readable medium (such as one or more nonvolatile memory elements, such as EPROM, EEPROM, Flash memory, a hard drive, and so on) that may store at least the following software (SW) modules:
a service period (SP) scheduling SW module 342 to schedule access to the wireless medium by a plurality of STAs over one or more TWT service periods, the SP scheduling SW module 342 including:
   a primary scheduling submodule 343 to schedule communications with a primary subset of the STAs, for a given TWT service period, using a first signaling technique (such as MU-MIMO);
   a secondary scheduling submodule 344 to schedule communications with a secondary subset of the STAs, for a given TWT service period, using a second signaling technique (such as OFDMA); and
   a legacy scheduling submodule 345 to release the wireless medium, for at least a portion of a TWT service period, to allow legacy (contention-based) access to the wireless medium.
      Each software module includes instructions that, when executed by processor 330, cause AP 300 to perform the corresponding functions. The non-transitory computer-readable medium of memory 340 thus includes instructions for performing all or a portion of the operations described below with respect to FIGS. 6-7.

Processor 330, which is shown in the example of FIG. 3 as coupled to PHY device 310 via MAC 320, to memory 340, and to network interface 350 may be any suitable one or more processors capable of executing scripts or instructions of one or more software programs stored in AP 300 (such as within memory 340). For example, processor 330 may execute the SP scheduling SW module 342 to schedule access to the wireless medium by a plurality of STAs over one or more TWT service periods. In executing the SP scheduling SW module 342, the processor 330 may further execute the primary scheduling submodule 343 to schedule communications with a primary subset of the STAs, for a given TWT service period, using a first signaling technique (such as MU-MIMO). Further, in executing the SP scheduling SW module 342, the processor 330 may also execute the secondary scheduling submodule 344 to schedule communications with a secondary subset of the STAs, for a given TWT service period, using a second signaling technique (such as OFDMA). Still further, in executing the SP scheduling SW module 342, the processor 330 may execute the legacy scheduling submodule 345 to release the wireless medium, for at least a portion of a TWT service period, to allow legacy (contention-based) access to the medium.

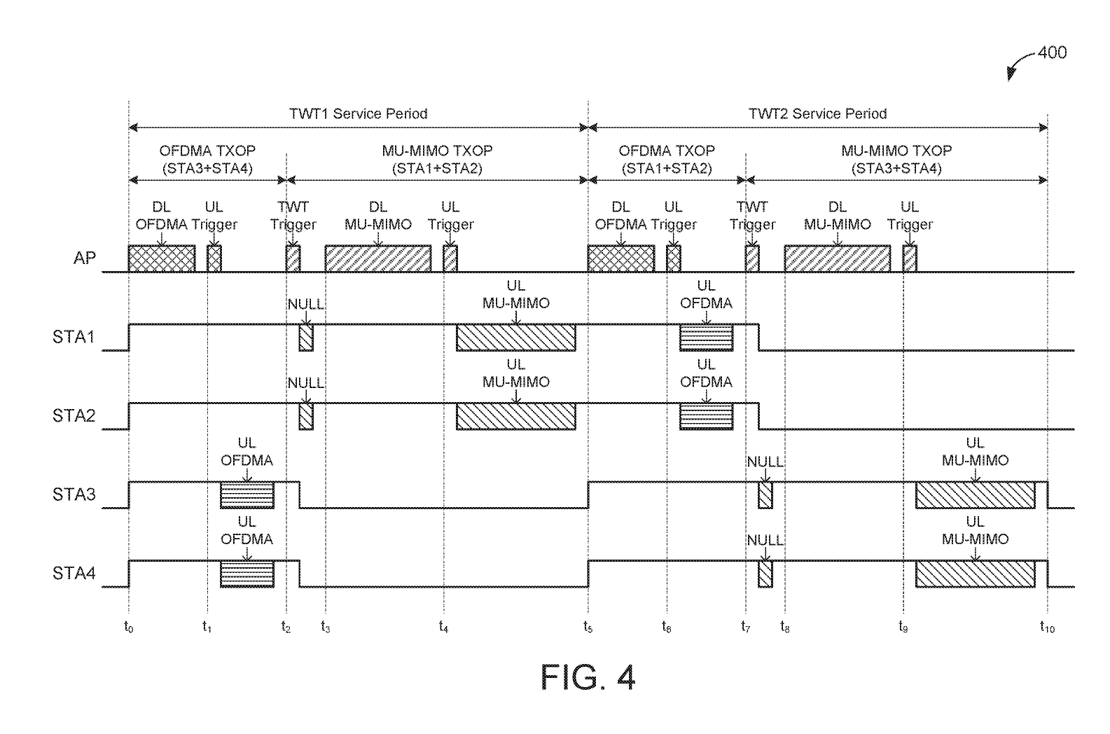

FIG. 4 is a timing diagram 400 depicting an example scheduling of access to a wireless medium using hybrid signaling techniques. The AP may be one embodiment of AP 110 of FIG. 1 and/or AP 300 of FIG. 3. The stations STA1-STA4 may be respective embodiments of stations STA1-STA4 of FIG. 1. For simplicity, only four stations STA1-STA4 are shown in the example of FIG. 4. However, in other embodiments, the AP may schedule access for fewer or more STAs than those depicted in the example of FIG. 4.

In the example of FIG. 4, stations STA1 and STA2 are the primary subset of STAs assigned to a first TWT (TWT1) service period, and stations STA3 and STA4 are the secondary subset of STAs assigned to the TWT1 service period. Accordingly, a TWT schedule (not shown for simplicity) may be sent to the stations STA1-STA4 indicating that each of the stations STA1-STA4 is assigned to (and thus scheduled to access the wireless medium during) the TWT1 service period, as well as a time at which the TWT1 service period is scheduled to occur (such as time t₀). For example, the TWT schedule may be provided in beacon frames broadcast by the AP at TBTT intervals. Furthermore, stations STA3 and STA4 are the primary subset of STAs assigned to a second TWT (TWT2) service period, and stations STA1 and STA2 are the secondary subset of STAs assigned to the TWT2 service period. Accordingly, the TWT schedule broadcast to the stations STA1-STA4 may further indicate that each of the stations STA1-STA4 is further assigned to the TWT2 service period, as well as a time at which the TWT2 service period is scheduled to occur (such as time t₅).

The TWT1 service period begins at time t₀. Since each of the stations STA1-STA4 is scheduled to access the wireless medium during the TWT1 service period, the stations STA1-STA4 may each wake up at time t₀ to listen for communications from the AP. In example embodiments, the TWT1 service period (from times t₀ to t₅) may be subdivided into an OFDMA TXOP (from times t₀ to t₂) and an MU-MIMO TXOP (from times t₂ to t₅). In some aspects, the AP may allow stations STA3 and STA4 (corresponding to the secondary subset of STAs for the TWT1 service period) to access the wireless medium during the OFDMA TXOP of the TWT1 service period, and may allow stations STA1 and STA2 (corresponding to the primary subset of STAs for the TWT1 service period) to access the wireless medium during the MU-MIMO TXOP within the TWT1 service period.

During the OFDMA TXOP, from times t₀ to t₂, the AP may communicate with stations STA3 and STA4 using OFDMA signaling techniques. More specifically, at time t₀, the AP may transmit DL data to the stations STA3 and STA4, concurrently, via a plurality of RUs. For example, the AP may allocate a first set of RUs to STA3 and a second set of RUs to STA4. Thus, the DL data for STA3 may be transmitted over the first set of RUs and the DL data for STA4 may be transmitted over the second set of RUs. At time t₁, the AP may transmit (or multicast) a UL trigger frame to the stations STA3 and STA4 to enable the stations STA3 and STA4 to transmit UL data to the AP. In some aspects, the UL trigger frame may indicate the respective RU allocations for each of the stations STA3 and STA4 to be used for UL transmissions. Upon receiving the UL trigger frame, the stations STA3 and STA4 may each transmit their UL data to the AP, concurrently, via their respective RUs.

During the MU-MIMO TXOP, from times t₂ to t₅, the AP may communicate with stations STA1 and STA2 using MU-MIMO signaling techniques. More specifically, at time t₂, the AP may broadcast a TWT trigger frame to indicate that the AP is about to service stations STA1 and STA2. In example embodiments, the TWT trigger frame may include a cascade bit indicating that no additional TWT triggers will be transmitted for the duration of the TWT1 service period (cascade bit=0). Upon receiving the TWT trigger frame with a zero cascade bit, stations STA3 and STA4 may enter a power saving state (since they will not be serviced for the remainder of the TWT1 service period).

In some embodiments, the AP may use the TWT trigger frame to poll the stations STA1 and STA2 for their respective UL buffer sizes. For example, the AP may determine what proportion of the MU-MIMO TXOP (from times t₂ to t₅) to allocate for DL and/or UL MU-MIMO transmissions based on the amount of buffered DL data to be transmitted to the stations STA1 and STA2 and the amount of buffered UL data to be transmitted by the stations STA1 and STA2. Thus, in example embodiments, each of the stations STA1 and STA2 may respond to the TWT trigger frame by transmitting a NULL quality of service (QoS) frame, indicating its respective UL buffer size, to the AP.

Still further, in some embodiments, the AP may use the TWT trigger frame as a “sounding packet” to acquire channel state information (CSI) for each of the stations STA1 and STA2. For example, the AP may use the CSI to determine a modulation and coding scheme (MCS) that is optimized for communications with each of the stations STA1 and STA2 based at least in part on their respective channel conditions. Thus, each of the stations STA1 and STA2 may respond to the TWT trigger frame by measuring the CSI of its respective communications channel, and feeding back the CSI to the AP. For example, the stations STA1 and STA2 may provide the CSI to the AP via NULL QoS frames or compressed beamforming (CBF) frames (not shown for simplicity).

At time t₃, the AP may transmit DL data to the stations STA1 and STA2, concurrently, via a plurality of spatial streams. For example, the data signaled on the plurality of spatial streams may be encoded such that each of the stations STA1 and STA2 may decode its respective data from the plurality of spatial streams. In some aspects, the DL data for each of the stations STA1 and STA2 may be encoded and/or transmitted according to an MCS that is optimized for the particular STA. At time t₄, the AP may transmit a UL trigger frame to the stations STA1 and STA2 to enable each of the stations STA1 and STA2 to transmit UL data to the AP. In some aspects, the UL trigger frame may indicate the MCSs to be used for UL transmissions by each of the stations STA1 and STA2. Upon receiving the UL trigger frame, the stations STA1 and STA2 may transmit their UL data to the AP, concurrently, in accordance with their respective MCSs.

The TWT2 service period begins at time t₅. Since each of the stations STA1-STA4 is each scheduled to access the wireless medium during the TWT2 service period, stations STA3 and STA4 may wake up at time t₅, while stations STA1 and STA2 may remain awake, to listen for communications from the AP. In example embodiments, the TWT2 service period (from times t₅ to t₁₀) may be subdivided into an OFDMA TXOP (from times t₅ to t₇) and an MU-MIMO TXOP (from times t₇ to t₁₀). In some aspects, the AP may allow stations STA1 and STA2 (corresponding to the secondary subset of STAs for the TWT2 service period) to access the wireless medium during the OFDMA TXOP of the TWT2 service period, and may allow stations STA3 and STA4 (corresponding to the primary subset of STAs for the TWT2 service period) to access the wireless medium during the MU-MIMO TXOP of the TWT2 service period.

During the OFDMA TXOP, from times t₅ to t₇, the AP may communicate with stations STA1 and STA2 using OFDMA signaling techniques. As described above, at time t₅, the AP may transmit DL data to the stations STA1 and STA2, concurrently, via a plurality of RUs. For example, the AP may transmit DL data for STA1 over a first set of RUs, and may transmit DL data for STA2 over a second set of RUs. At time t₆, the AP may transmit (or multicast) a UL trigger frame to the stations STA1 and STA2 to enable the stations STA1 and STA2 to transmit UL data to the AP. In some aspects, the UL trigger frame may indicate the RU allocations for each of the stations STA1 and STA4 to be used for UL transmissions. Upon receiving the UL trigger frame, the stations STA1 and STA2 may each transmit their UL data to the AP, concurrently, via their respective RUs.

During the MU-MIMO TXOP, from times t₇ to t₁₀, the AP may communicate with stations STA3 and STA4 using MU-MIMO signaling techniques. As described above, at time t₇, the AP may broadcast a TWT trigger frame to indicate that the AP is about to service stations STA3 and STA4. In example embodiments, the TWT trigger frame may include a cascade bit indicating that no additional TWT triggers will be transmitted for the duration of the TWT2 service period (cascade bit=0). Upon receiving the TWT trigger frame with a zero cascade bit, stations STA1 and STA2 may enter a power saving state (since they will not be serviced for the remainder of the TWT2 service period).

In some embodiments, the AP may use the TWT trigger frame to poll the stations STA3 and STA4 for their respective UL buffer sizes, for example, to determine what proportion of the MU-MIMO TXOP is to be allocated for DL and/or UL MU-MIMO transmissions. As described above, each of the stations STA3 and STA4 may respond to the TWT trigger frame by transmitting a NULL QoS frame, indicating its respective UL buffer size, to the AP. Still further, in some embodiments, the AP may use the TWT trigger frame as a sounding packet to acquire CSI for each of the stations STA3 and STA4, for example, to determine an optimized MCS for each STA. As described above, each of the stations STA3 and STA4 may respond to the TWT trigger frame by measuring the CSI of its respective communications channel and feeding back the CSI to the AP, for example, via the NULL QoS frames or CBF frames (not shown for simplicity).

At time t₈, the AP may transmit DL data to the stations STA3 and STA4, concurrently, via a plurality of spatial streams. In some aspects, the DL data for each of the stations STA3 and STA4 may be encoded and/or transmitted according to an MCS that is optimized for the particular STA. At time t₉, the AP may transmit a UL trigger frame to the stations STA3 and STA4 to enable each of the stations STA3 and STA4 to transmit UL data to the AP. In some aspects, the UL trigger frame may indicate the MCSs to be used for UL transmissions by each of the stations STA3 and STA4. Upon receiving the UL trigger frame, the stations STA3 and STA4 may transmit their UL data to the AP, concurrently, in accordance with their respective MCSs.

By implementing hybrid signaling techniques (such as the combination of OFDMA and MU-MIMO, as described above) the AP may enable each of the stations STA1-STA4 to transmit and/or receive at least a short burst of data traffic during each TWT service period. This may substantially reduce the latency of communications for each of the stations STA1-STA4. For example, each of the stations STA1-STA4 may be given a chance to transmit or receive at least some data (such as high-priority data), at regular intervals (such as during each TWT service period), without having to wait for its own dedicated TWT service period (or a subsequent beacon interval). Furthermore, each of the stations STA1-STA4 may be given “priority” access to the wireless medium (for high-throughput communications), for example to transmit both high-priority data and low-priority data, when assigned to the primary subset of STAs for a particular TWT service period. For example, as shown in FIG. 4, the MU-MIMO TXOPs may be longer in duration than the OFDMA TXOPs to ensure that the primary subset of STAs for each TWT service period are given priority access to the wireless medium. In some embodiments, the AP may determine what proportion of a given TWT service period is to be allocated for the OFDMA and/or MU-MIMO TXOPs based at least in part on the amount and/or priority of buffered DL/UL data for each of the stations STA1-STA4.

In the example of FIG. 4, the AP uses two different MU signaling techniques (such as OFDMA and MU-MIMO) to communicate with the station STA1-STA4 during each TWT service period. However, in other embodiments, the AP may incorporate additional and/or other signaling techniques than those shown in the example of FIG. 4. For example, the AP may communicate with the primary subset of STAs using a first MU signaling technique, and may communicate with the secondary subset of STAs using a second MU signaling technique. In some aspects, the first MU signaling technique may be configured to provide greater overall throughput than the second MU signaling technique. In some other aspects, the second MU signaling technique may be configured to provide concurrent communications with a greater number of STAs than the first MU signaling technique.

Still further, in some embodiments, the AP may release control of the wireless medium, for at least a portion of the TWT service period, to allow access by legacy devices (such as those without MU signaling capabilities). More specifically, upon release of the wireless medium, STAs and/or legacy devices (not shown for simplicity) that are not scheduled to access the wireless medium during the given TWT service period may contend for access to the wireless medium using well-known CSMA/CA techniques (such as defined by legacy IEEE 802.11 standards). In example embodiments, the legacy IEEE 802.11 standard may correspond to any of the IEEE 802.11a, b, g, or n standards.

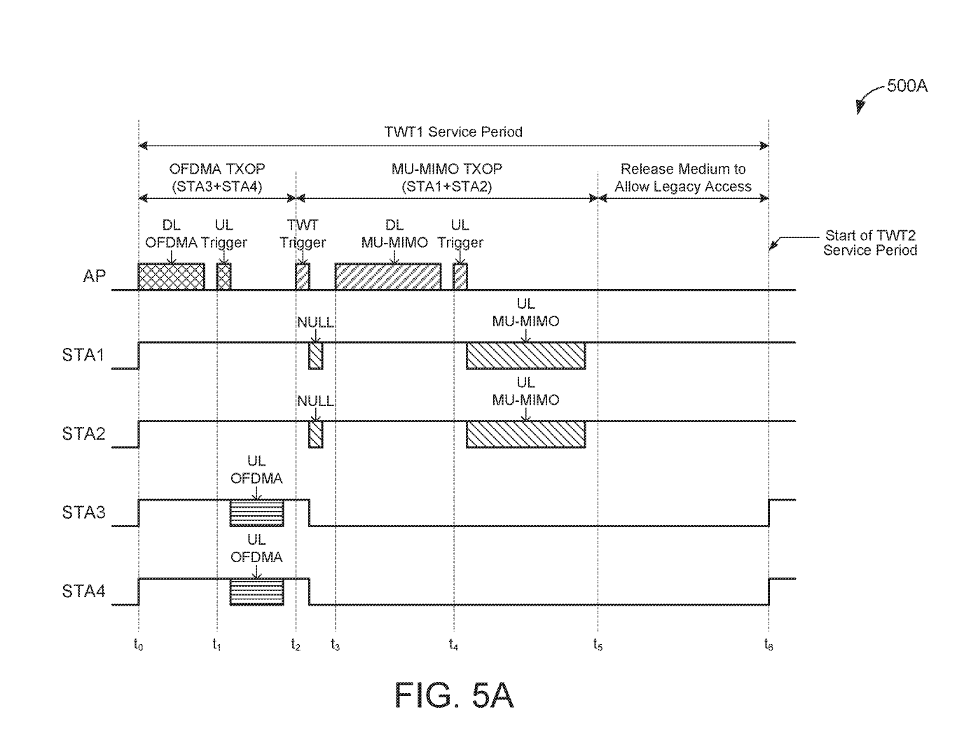

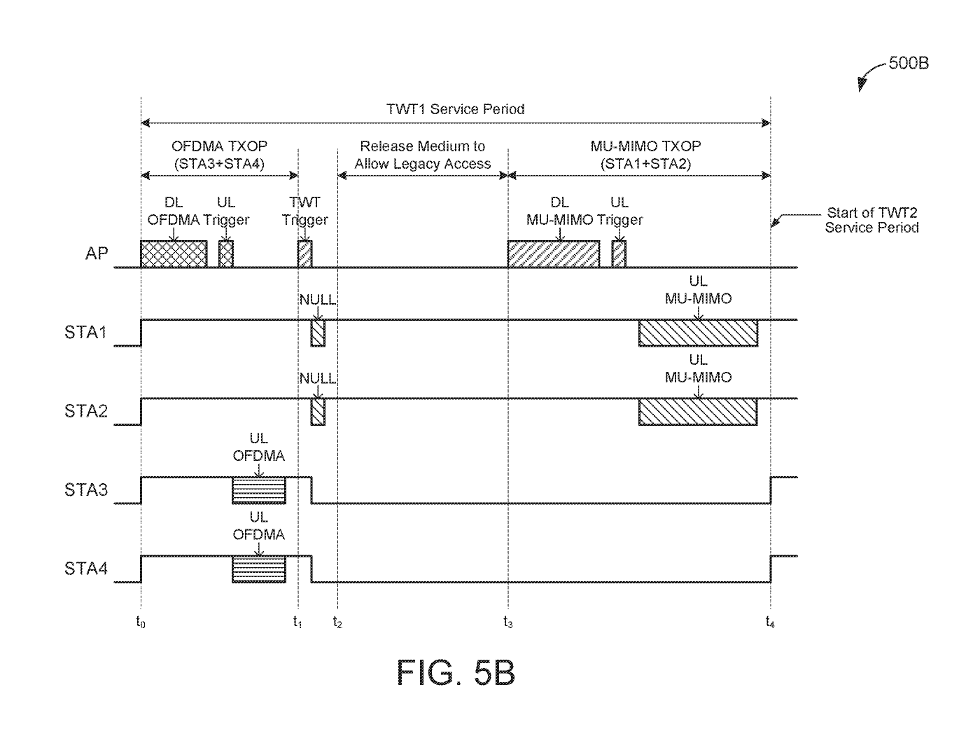

FIGS. 5A-5B are timing diagrams 500A and 500B depicting example allocations of transmit opportunities (TXOPs) based on different signaling techniques within a given service period. The AP may be one embodiment of AP 110 of FIG. 1 and/or AP 300 of FIG. 3. The stations STA1-STA4 may be respective embodiments of stations STA1-STA4 of FIG. 1. In the examples of FIGS. 5A and 5B, each of the stations STA1-STA4 may be an HE STA capable of operating in accordance with the IEEE 802.11ax specification. For simplicity, only four stations STA1-STA4 are shown in the examples of FIGS. 5A-5B. However, in other embodiments, the AP may schedule access for fewer or more STAs than those depicted in the examples of FIGS. 5A-5B. In the examples of FIGS. 5A and 5B, stations STA1 and STA2 are the primary subset of STAs assigned to a first TWT (TWT1) service period, and stations STA3 and STA4 are the secondary subset of STAs assigned to the TWT1 service period.

The TWT1 service period begins at time t₀. Since each of the stations STA1-STA4 is scheduled to access the wireless medium during the TWT1 service period, the stations STA1-STA4 may each wake up at time t₀ to listen for communications from the AP. In example embodiments, the TWT1 service period (from times t₀ to t₆) may be subdivided into an OFDMA TXOP (from times t₀ to t₂), an MU-MIMO TXOP (from times t₂ to t₅), and a legacy access interval (from times t₅ to t₆). In some aspects, the AP may allow stations STA3 and STA4 (corresponding to the secondary subset of STAs for the TWT1 service period) to access the wireless medium during the OFDMA TXOP, and may allow stations STA1 and STA2 (corresponding to the primary subset of STAs for the TWT1 service period) to access the wireless medium during the MU-MIMO TXOP. Still further, in some aspects, the AP may release control of the wireless medium during the legacy access interval to give legacy devices (not shown for simplicity) an opportunity to access the wireless medium.

During the OFDMA TXOP, from times t₀ to t₂, the AP may communicate with stations STA3 and STA4 using OFDMA signaling techniques. As described above, at time t₀, the AP may transmit DL data to the stations STA3 and STA4, concurrently, via a plurality of RUs. For example, the AP may transmit DL data for STA3 over a first set of RUs, and may transmit DL data for STA4 over a second set of RUs. At time t₁, the AP may transmit (or multicast) a UL trigger frame to the stations STA3 and STA4 to enable the stations STA3 and STA4 to transmit UL data to the AP. In some aspects, the UL trigger frame may indicate the RU allocations for each of the stations STA3 and STA4 to be used for UL transmissions. Upon receiving the UL trigger frame, the stations STA3 and STA4 may each transmit their UL data to the AP, concurrently, via their respective RUs.

During the MU-MIMO TXOP, from times t₂ to t₅, the AP may communicate with stations STA1 and STA2 using MU-MIMO signaling techniques. As described above, at time t₂, the AP may broadcast a TWT trigger frame to indicate that the AP is about to service stations STA1 and STA2. In example embodiments, the TWT trigger frame may include a cascade bit indicating that no additional TWT triggers will be transmitted for the duration of the TWT1 service period (cascade bit=0). Upon receiving the TWT trigger frame with a zero cascade bit, stations STA3 and STA4 may enter a power saving state (since they will not be serviced for the remainder of the TWT1 service period).

In some embodiments, the AP may use the TWT trigger frame to poll the stations STA1 and STA2 for their respective UL buffer sizes, for example, to determine what proportion of the MU-MIMO TXOP is to be allocated for DL and/or UL MU-MIMO transmissions. As described above, each of the stations STA1 and STA2 may respond to the TWT trigger frame by transmitting a NULL QoS frame, indicating its respective UL buffer size, to the AP. Still further, in some embodiments, the AP may use the TWT trigger frame as a sounding packet to acquire CSI for each of the stations STA1 and STA2, for example, to determine an optimized MCS for each STA. As described above, each of the stations STA1 and STA2 may respond to the TWT trigger frame by measuring the CSI of its respective communications channel and feeding back the CSI to the AP, for example, via the NULL QoS frames or CBF frames (not shown for simplicity).

At time t₃, the AP may transmit DL data to the stations STA1 and STA2, concurrently, via a plurality of spatial streams. In some aspects, the DL data for each of the stations STA1 and STA2 may be encoded and/or transmitted according to an MCS that is optimized for the particular STA. At time t₄, the AP may transmit a UL trigger frame to the stations STA1 and STA2 to enable each of the stations STA1 and STA2 to transmit UL data to the AP. In some aspects, the UL trigger frame may indicate the MCSs to be used for UL transmissions by each of the stations STA1 and STA2. Upon receiving the UL trigger frame, the stations STA1 and STA2 may transmit their UL data to the AP, concurrently, in accordance with their respective MCSs.

During the legacy access interval, from times t₅ to t₆, the AP may release control of the wireless medium to allow legacy devices (not shown for simplicity) to access the wireless medium. For example, the legacy devices may contend for access to the wireless medium using well-known CSMA/CA techniques. In some aspects, the stations STA1-STA4 belonging to the TWT1 service period may not compete with legacy devices for access to the wireless medium. For example, because the stations STA1-STA4 are configured for scheduled access for the duration of the TWT1 service period, the stations STA1-STA4 may not attempt to access the wireless medium on their own (without being triggered by the AP). Furthermore, stations STA3 and STA4 may remain in the power saving state for the remainder of the TWT1 service period and thus may not be awake to contend for medium access during the legacy access interval.

The example implementations further recognize that, although it may be desirable to provide legacy access to the wireless medium, the AP may need to contend with the legacy devices to regain control of the medium, for example, to resume scheduled access. However, by releasing the wireless medium at the end of the TWT1 service period, there is no guarantee that the AP will be able to regain control of the medium by the start of a subsequent TWT (TWT2) service period. Thus, it may be desirable to schedule the legacy access interval such that the AP has enough time t₀ regain control of the wireless medium far in advance of (or at least a threshold duration before) the end of the current TWT service period.

In some embodiments, the AP may schedule the legacy access interval to occur between the OFDMA TXOP and the MU-MIMO TXOP, for example, as shown in FIG. 5B. During the OFDMA TXOP, from times t₀ to t₁, the AP may communicate with stations STA3 and STA4 using OFDMA signaling techniques (such as described above with respect to FIG. 5A). Then, at time t₁, the AP may broadcast a TWT trigger frame to indicate that the AP is about to service stations STA1 and STA2. In example embodiments, the TWT trigger frame may include a cascade bit indicating that no additional TWT triggers will be transmitted for the duration of the TWT1 service period (cascade bit=0), for example, to allow stations STA3 and STA4 to enter the power saving state.

After broadcasting the TWT trigger frame, rather than immediately initiating MU-MIMO communications with stations STA1 and STA2 (such as shown in FIG. 5A), the AP may release control of the wireless medium to allow contention-based access by legacy devices from times t₂ to t₃. Upon expiration of the legacy access interval, the AP may contend for access to the wireless medium, for example, using CSMA/CA techniques. More specifically, the AP may begin contending for access to the wireless medium at least a threshold duration before the MU-MIMO TXOP is scheduled to occur. This may ensure that the AP is able to regain control of the wireless medium prior to the start of the MU-MIMO TXOP (at time t₃). In the example of FIG. 5B, the AP successfully regains control of the wireless medium and initiates the MU-MIMO TXOP at time t₃. During the MU-MIMO TXOP, from times t₃ to t₄, the AP may communicate with stations STA1 and STA2 using MU-MIMO signaling techniques (such as described above with respect to FIG. 5A).

FIG. 6 is an illustrative flowchart depicting an operation 600 for scheduling access to a wireless medium, in accordance with example embodiments. With reference for example to FIG. 1, the operation 600 may be implemented by the AP 110 to schedule the access to the wireless medium (WLAN 120) for each of the stations STA1-STA4. More specifically, the operation 600 may enable each of the stations STA1-STA4 to communicate with the AP using at least a first MU signaling technique or a second MU signaling technique during a given TWT service period.

The AP 110 may first schedule each of the STAs to access the wireless medium during a TWT service period (610). In some embodiments, the AP 110 may group each of the stations STA1-STA4 into at least a primary subset of STAs and a secondary subset of STAs for the given TWT service period (such as described with respect to FIGS. 2 and 4). The primary subset of STAs may be given “priority” access to the wireless medium during the given TWT service period. In contrast, the secondary subset of STAs may be given more limited access to the wireless medium during the same TWT service period. In some aspects, the AP 110 may assign a relatively small number of the stations STA1-STA4 to the primary subset of STAs, and may assign the remainder of the stations STA1-STA4 to the secondary subset of STAs.

During a first portion of the TWT service period, the AP 110 may communicate with a first subset of STAs using a first signaling technique (620). In some examples, the first subset of STAs may correspond to the secondary subset of STAs. Accordingly, the first signaling technique may be configured to provide low-latency access to a relatively large number of STAs. In some embodiments, the first signaling technique may correspond to an OFDMA signaling technique. The first portion of the TWT service period may thus coincide with (or correspond to) an OFDMA TXOP. In some aspects, the AP may determine a duration of the first portion of the TWT service period based at least in part on an amount and/or priority of data to be transmitted to and/or from each of the stations STA1-STA4. For example, the AP may schedule the OFDMA TXOP based at least in part on the DL/UL buffer sizes for each of the stations STA1-STA4.

During a second portion of the TWT service period, the AP 110 may communicate with a second subset of STAs using a second signaling technique (630). In some examples, the second subset of STAs may correspond to the primary subset of STAs. Accordingly, the second signaling technique may be configured to provide high-throughput access to a relatively small number of STAs. In some embodiments, the second signaling technique may correspond to an MU-MIMO signaling technique. The second portion of the TWT service period may thus coincide with (or correspond to) an MU-MIMO TXOP. In some aspects, the AP may determine a duration of the second portion of the TWT service period based at least in part on an amount and/or priority of data to be transmitted to and/or from each of the stations STA1-STA4. For example, the AP may schedule the MU-MIMO TXOP based at least in part on the DL/UL buffer sizes for each of the stations STA1-STA4.

FIG. 7 is an illustrative flowchart depicting an operation 700 for scheduling access to a wireless medium using hybrid signaling techniques. With reference for example to FIG. 1, the operation 700 may be implemented by the AP 110 to schedule access to the wireless medium for each of the stations STA1-STA4. More specifically, the operation 700 may enable HE STAs (such as stations STA1-STA4) to communicate with the AP 110 using at least an OFDMA or MU-MIMO signaling technique during a given TWT service period, while also allowing legacy devices (not shown in FIG. 1) to access the wireless medium using contention-based access mechanisms.

The AP 110 may first subdivide the TWT service period, for the plurality of STAs, into at least an OFDMA transmit opportunity and an MU-MIMO transmit opportunity (710). For example, as described above with respect to FIGS. 2 and 4, the OFDMA TXOP may be configured to provide low-latency communications to a relatively large number of STAs (via OFDMA communications), and the MU-MIMO TXOP may provide high-throughput communications to a relatively small number of STAs (via MU-MIMO communications). For some embodiments, the duration of the MU-MIMO TXOP may be longer than the OFDMA TXOP. In other embodiments, the AP 110 may determine respective durations for each of the OFDMA and MU-MIMO TXOPs based at least in part on an amount and/or priority of data to be transmitted to and/or from each of the stations STA1-STA4 (such as indicated by the DL/UL buffer sizes for each of the STAs).

The AP 110 may assign a primary subset of the STAs to the MU-MIMO TXOP and a secondary subset of the STAs to the OFDMA TXOP (720). As described above, the primary subset of STAs may be given priority access to the wireless medium during the given TWT service period. For example, the primary subset of STAs may represent a small group of STAs that the AP is primarily configured to service during the TWT service period. Accordingly, it may be desirable to provide high-throughput communications and/or longer medium access to the primary subset of STAs. In contrast, the secondary subset of STAs may be given more limited access to the wireless medium during the same TWT service period. For example, the secondary subset of STAs may represent the remaining HE STAs that are merely serviced during the given TWT service period to reduce their communications latencies. Accordingly, it may be desirable to provide low-latency communications and/or shorter medium access to the secondary subset of STAs.

The AP 110 may then initiate the OFDMA TXOP (730). In example embodiments, the start of the OFDMA TXOP may coincide with the beginning of the TWT service period (such as shown in FIGS. 4, 5A, and 5B). In some aspects, the AP 110 may initiate the OFDMA TXOP by transmitting DL data (in an OFDMA format) to the secondary subset of STAs. For example, because each of the stations STA1-STA4 is already configured to be awake at the start of the TWT service period, the secondary subset of STAs may already be listening for DL communications from the AP 110. In some embodiments, the AP 110 may communicate with the secondary subset of STAs for the duration of the OFDMA TXOP (735). More specifically, the AP 110 may communicate with the secondary subset of STAs using OFDMA signaling techniques. For example, the AP 110 may concurrently transmit DL data to, and receive UL data from, the secondary subset of STAs via a plurality of RUs (such as described with respect to FIGS. 4, 5A, and 5B).

Upon expiration of the OFDMA TXOP, the AP 110 may temporarily release control of the wireless medium (740). In some embodiments, the AP 110 may allow the secondary subset of STAs to enter a power saving state at this time. For example, the AP 110 may broadcast a TWT trigger frame, including a zero cascade bit, and indicating that the AP 110 is about to service the primary subset of STAs. However, rather than initiate communications with the primary subset of STAs, the AP 110 may simply allow a threshold duration to expire (without any communication on the wireless medium). During this time, other (legacy) devices may sense that the wireless medium is clear and contend for medium access (using CSMA/CA techniques). Accordingly, the AP 110 may communicate with legacy STAs for at least a portion of the TWT service period (745).

The AP 110 may regain control of the wireless medium prior to the start of the MU-MIMO TXOP (750). For example, to resume scheduled access, the AP 110 may need to contend with the legacy devices to regain control of the medium. In some embodiments, the AP 110 may begin contending for access to the wireless medium at least a threshold duration before the MU-MIMO TXOP is scheduled to occur. This may ensure that the AP 110 is able to regain control of the wireless medium prior to the start of the MU-MIMO TXOP.

The AP 110 may then initiate the MU-MIMO TXOP (760). In some embodiments, the AP 110 may initiate the MU-MIMO TXOP by broadcasting a TWT trigger frame indicating that the AP 110 is about to service the primary subset of STAs. Alternatively, if the AP 110 has already broadcasted a TWT trigger frame prior to releasing control of the wireless medium (such as described above), the AP 110 may initiate the MU-MIMO TXOP by transmitting DL data (in an MU-MIMO format) to the primary subset of STAs. For example, because the primary subset of STAs is already configured to be awake in response to the TWT trigger frame, the primary subset of STAs may already be listening for DL communications from the AP 110. In some embodiments, the AP 110 may communicate with the primary subset of STAs for the duration of the MU-MIMO TXOP (765). More specifically, the AP 110 may communicate with the primary subset of STAs using MU-MIMO signaling techniques. For example, the AP 110 may concurrently transmit DL data to, and receive UL data from, the primary subset of STAs via a plurality of spatial streams (such as described with respect to FIGS. 4, 5A, and 5B).

FIG. 8 is an illustrative flowchart depicting a more detailed operation 800 for scheduling access to a wireless medium using hybrid signaling techniques. With reference for example to FIG. 1, the operation 800 may be implemented by the AP 110 to schedule access to the wireless medium for each of the stations STA1-STA4. More specifically, the operation 800 may enable each of the stations STA1-STA4 to communicate with the AP 110 using at least an OFDMA or MU-MIMO signaling technique during a given TWT service period. The operation 800 may further allow legacy devices (not shown in FIG. 1) to access the wireless medium using contention-based access mechanisms.

The AP 110 may first broadcast a TWT schedule to the plurality of STAs (810). For example, the TWT schedule may be included in a beacon frame broadcast to the stations STA1-STA4 at the start of a beacon interval (such as shown in FIG. 2). The TWT schedule may indicate which of the stations STA1-STA4 are assigned to one or more TWT service periods scheduled to occur within the corresponding beacon interval. For some embodiments, most (if not all) of the stations STA1-STA4 may be assigned to each of the TWT service periods (such as described above with respect to FIGS. 4, 5A, and 5B). In some aspects, each of the stations STA1-STA4 may enter a power saving state until the start of their respective TWT service periods.

For some embodiments, the AP 110 may poll a secondary subset of STAs for buffered UL data prior to the start of a particular TWT service period (812). As described above, the secondary subset of STAs may be given limited access to the wireless medium (via OFDMA communications) during the upcoming TWT service period. In some embodiments, the AP 110 may allocate an OFDMA TXOP for the secondary subset of STAs. The AP 110 may determine what proportion of the OFDMA TXOP to allocate for DL and/or OFDMA transmissions based on an amount of buffered DL data to be transmitted to the secondary subset of STAs and an amount of buffered UL data to be transmitted by the secondary subset of STAs.

At the start of the TWT service period, the AP 110 may initiate OFDMA communications with the secondary subset of STAs (820). As described above, the AP 110 may communicate with the secondary subset of STAs using low-latency (such as OFDMA) signaling techniques. As shown in FIGS. 4, 5A, and 5B, each of the stations STA1-STA4 may wake up at the start of the TWT service period to listen for communications from the AP. However, during the OFDMA TXOP, the AP 110 may communicate with only the secondary subset of STAs. More specifically, the AP 110 may schedule the OFDMA TXOP to allow the secondary subset of STAs to transmit and/or receive relatively short bursts of data traffic, for example, to reduce the overall communications latency for the corresponding STAs.

The AP 110 may then enable or otherwise cause the secondary subset of STAs to enter a power saving state (830). For example, the AP 110 may transmit (broadcast or multicast) a TWT trigger frame, upon termination of the OFDMA TXOP, to indicate that the AP 110 is about to service a primary subset of STAs. In example embodiments, the TWT trigger frame may include a cascade bit indicating that no additional TWT triggers will be transmitted for the duration of the TWT service period (cascade bit=0). Upon receiving the TWT trigger frame with a zero cascade bit, the secondary subset of STAs may enter the power saving state (since they will not be serviced for the remainder of the service period).

In some aspects, the AP 110 may poll the primary subset of STAs for buffered UL data (840). As described above, the primary subset of STAs may be given priority access to the wireless medium (via MU-MIMO communications) during the current TWT service period. In some embodiments, the AP 110 may allocate an MU-MIMO TXOP for the primary subset of STAs. In example embodiments, the AP 110 may use the TWT trigger frame to poll the primary subset of STAs for their respective UL buffer sizes. Each STA in the primary subset may respond to the TWT trigger frame (or poll request) by transmitting a respective NULL QoS frame, indicating its UL buffer size, to the AP 110. The AP 110 may then determine what proportion of the MU-MIMO TXOP to allocate for DL and/or UL MU-MIMO transmissions based on the amount of buffered DL data to be transmitted to the primary subset of STAs and the amount of buffered UL data to be transmitted by the primary subset of STAs.

Still further, in some aspects, the AP 110 may perform channel sounding to acquire CSI from the primary subset of STAs (850). In example embodiments, the AP 110 may use the TWT trigger frame as a sounding packet to acquire CSI for each of the STAs in the primary subset. For example, the AP 110 may use the CSI to determine an MCS that is optimized for communications with each of the STAs in the primary subset based at least in part on their respective channel conditions. The primary subset of STAs may respond to the TWT trigger frame (or sounding packet) by measuring their respective CSI and feeding back the CSI to the AP 110, for example, via NULL QoS frames or separate CBF frames.

The AP 110 may subsequently release the wireless medium for access by legacy devices (860). In example embodiments, the AP 110 may release control of the wireless medium, for at least a portion of the TWT service period (corresponding to a legacy access interval), to allow legacy devices (such as those without MU signaling capabilities) a chance to access the wireless medium. For example, during the legacy access interval, the legacy devices may contend for access to the wireless medium using well-known CSMA/CA techniques (such as defined by the IEEE 802.11 standard). In some aspects, the AP 110 may also contend to regain control of the wireless medium prior to the scheduled MU-MIMO TXOP.

Upon regaining control of the wireless medium, the AP 110 may initiate MU-MIMO communications with the primary subset of STAs (870). As described above, the AP 110 may communicate with the primary subset of STAs using high-throughput (such as MU-MIMO) signaling techniques. As shown in FIGS. 4, 5A, and 5B, the primary subset of STAs may remain awake for the duration of the TWT service period. Thus, during the MU-MIMO TXOP, the AP 110 may communicate with only the primary subset of STAs. More specifically, the AP 110 may schedule the MU-MIMO TXOP to allow the primary subset of STAs to transmit and/or receive longer bursts of data traffic, for example, to increase the aggregate throughput of communications for the corresponding STAs.

For some embodiments, the operation 800 may be repeated at the start of each beacon interval. For example, the AP 110 may dynamically update the TWT schedule to reflect any changes to the number of STAs and/or amount of data traffic in the WLAN 120. Furthermore, sub-steps 820-870 may be repeated for each TWT service period occurring within a given beacon interval. For example, as described above with respect to FIG. 4, the AP 110 may ensure that each of the stations STA1-STA4 is provided an opportunity for high-throughput access to the wireless medium (such as a MU-MIMO TXOP) during a given beacon interval. Thus, each of the stations STA1-STA4 may be assigned to the primary subset of STAs for at least one TWT service period within the beacon interval.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of managing communications between an access point (AP) and a plurality of wireless stations (STAs) over a wireless medium, the method being performed by the AP and comprising:
scheduling each of the plurality of STAs to access the wireless medium during a first target wake time (TWT) service period;
during a first portion of the first TWT service period, communicating with a first subset of the plurality of STAs using a first signaling technique; and
during a second portion of the first TWT service period, communicating with a second subset of the plurality of STAs using a second signaling technique, wherein the second subset of the plurality of STAs does not include any STAs from the first subset.

2. The method of claim 1, wherein the first signaling technique is configured to provide concurrent communications with a greater number of STAs than the second signaling technique.

3. The method of claim 1, wherein the second signaling technique is configured to provide greater overall throughput than the first signaling technique.

4. The method of claim 1, wherein the first signaling technique is an orthogonal frequency division multiple access (OFDMA) signaling technique, and wherein the second signaling technique is a multi-user multiple-input multiple-output (MU-MIMO) signaling technique.

5. The method of claim 1, further comprising:
determining an amount of buffered data associated with each of the plurality of STAs; and
configuring respective durations of the first and second portions of the first TWT service period based at least in part on the amount of buffered data.

6. The method of claim 5, wherein the configuring is further based at least in part on priorities associated with the buffered data.

7. The method of claim 1, further comprising:
during a third portion of the first TWT service period, communicating with a third subset of the plurality of STAs using a third signaling technique that is different than each of the first and second signaling techniques.

8. The method of claim 7, further comprising:
releasing control of the wireless medium during the third portion of the first TWT service period to allow the third subset of the plurality of STAs to contend for access to the wireless medium.

9. The method of claim 8, further comprising:
scheduling the third portion of the first TWT service period to occur between the first and second portions of the first TWT service period.

10. The method of claim 1, further comprising:
scheduling each of the plurality of STAs to access the wireless medium during a second TWT service period;
during a first portion of the second TWT service period, communicating with a third subset of the plurality of STAs using the first signaling technique; and
during a second portion of the second TWT service period, communicating with a fourth subset of the plurality of STAs using the second signaling technique, wherein the fourth subset of the plurality of STAs does not include STAs from any of the second or third subsets.

11. An wireless communication device comprising:
one or more processors; and
a memory storing instructions that, when executed by the one or more processors, cause the wireless communication device to:
schedule each of a plurality of wireless stations (STAs) to access a wireless medium during a first target wake time (TWT) service period;
during a first portion of the first TWT service period, communicate with a first subset of the plurality of STAs using a first signaling technique; and
during a second portion of the first TWT service period, communicate with a second subset of the plurality of STAs using a second signaling technique, wherein the second subset of the plurality of STAs does not include any STAs from the first subset.

12. The wireless communication device of claim 11, wherein the first signaling technique is configured to provide concurrent communications with a greater number of STAs than the second signaling technique, and wherein the second signaling technique is configured to provide greater overall throughput than the first signaling technique.

13. The wireless communication device of claim 11, wherein the first signaling technique is an orthogonal frequency division multiple access (OFDMA) signaling technique, and wherein the second signaling technique is a multi-user multiple-input multiple-output (MU-MIMO) signaling technique.

14. The wireless communication device of claim 11, wherein execution of the instructions further causes the wireless communication device to:
determine an amount of buffered data associated with each of the plurality of STAs; and
configure respective durations of the first and second portions of the first TWT service period based at least in part on the amount of buffered data.

15. The wireless communication device of claim 14, wherein the configuring is further based at least in part on priorities associated with the buffered data.

16. The wireless communication device of claim 11, wherein execution of the instructions further causes the wireless communication device to:
during a third portion of the first TWT service period, communicate with a third subset of the plurality of STAs using a third signaling technique that is different than each of the first and second signaling techniques.

17. The wireless communication device of claim 16, wherein execution of the instructions further causes the wireless communication device to:
release control of the wireless medium during the third portion of the first TWT service period to allow the third subset of the plurality of STAs to contend for access to the wireless medium.

18. The wireless communication device of claim 11, wherein execution of the instructions further causes the wireless communication device to:
scheduling each of the plurality of STAs to access the wireless medium during a second TWT service period;
during a first portion of the second TWT service period, communicate with a third subset of the plurality of STAs using the first signaling technique; and
during a second portion of the second TWT service period, communicate with a fourth subset of the plurality of STAs using the second signaling technique, wherein the fourth subset of the plurality of STAs does not include STAs from any of the second or third subsets.

19. A wireless communication device comprising:
means for scheduling each of the plurality of STAs to access the wireless medium during a first target wake time (TWT) service period;
means for communicating with a first subset of the plurality of STAs, during a first portion of the first TWT service period, using a first signaling technique; and
means for communicating with a second subset of the plurality of STAs, during a second portion of the first TWT service period, using a second signaling technique, wherein the second subset of the plurality of STAs does not include any STAs from the first subset.

20. The wireless communication device of claim 19, wherein the first signaling technique is configured to provide concurrent communications with a greater number of STAs than the second signaling technique, and wherein the second signaling technique is configured to provide greater overall throughput than the first signaling technique

21. The wireless communication device of claim 19, wherein the first signaling technique is an orthogonal frequency division multiple access (OFDMA) signaling technique, and wherein the second signaling technique is a multi-user multiple-input multiple-output (MU-MIMO) signaling technique.

22. The wireless communication device of claim 19, further comprising:
means for determining an amount of buffered data associated with each of the plurality of STAs; and
means for configuring respective durations of the first and second portions of the first TWT service period based at least in part on the amount of buffered data and priorities associated with the buffered data.

23. The wireless communication device of claim 19, further comprising:
means for communicating with a third subset of the plurality of STAs, during a third portion of the first TWT service period, using a third signaling technique that is different than each of the first and second signaling techniques.

24. The wireless communication device of claim 23, further comprising:
means for releasing control of the wireless medium during the third portion of the first TWT service period to allow the third subset of the plurality of STAs to contend for access to the wireless medium.

25. The wireless communication device of claim 19, further comprising:
means for scheduling each of the plurality of STAs to access the wireless medium during a second TWT service period;
means for communicating with a third subset of the plurality of STAs, during a first portion of the second TWT service period, using the first signaling technique; and
means for communicating with a fourth subset of the plurality of STAs, during a second portion of the second TWT service period, using the second signaling technique, wherein the fourth subset of the plurality of STAs does not include STAs from any of the second or third subsets.

26. A non-transitory computer-readable medium storing instructions that, when executed by one or more processors of a wireless communication device, cause the wireless communication device to perform operations comprising:
scheduling each of the plurality of STAs to access the wireless medium during a first target wake time (TWT) service period;
during a first portion of the first TWT service period, communicating with a first subset of the plurality of STAs using a first signaling technique; and
during a second portion of the first TWT service period, communicating with a second subset of the plurality of STAs using a second signaling technique, wherein the second subset of the plurality of STAs does not include any STAs from the first subset.

27. The non-transitory computer-readable medium of claim 25, wherein the first signaling technique is an orthogonal frequency division multiple access (OFDMA) signaling technique, and wherein the second signaling technique is a multi-user multiple-input multiple-output (MU-MIMO) signaling technique.

28. The non-transitory computer-readable medium of claim 25, wherein execution of the instructions further causes the wireless communication device to:
determine an amount of buffered data associated with each of the plurality of STAs; and
configure respective durations of the first and second portions of the first TWT service period based at least in part on the amount of buffered data and priorities associated with the buffered data.

29. The non-transitory computer-readable medium of claim 25, wherein execution of the instructions further causes the wireless communication device to:
during a third portion of the first TWT service period, communicate with a third subset of the plurality of STAs using a third signaling technique that is different than each of the first and second signaling techniques.

30. The non-transitory computer-readable medium of claim 28, wherein execution of the instructions further causes the wireless communication device to:
release control of the wireless medium during the third portion of the first TWT service period to allow the third subset of the plurality of STAs to contend for access to the wireless medium.
